(19) United States
(12) Patent Application Publication
(10) Pub. No.: US 2023/0388383 A1
(43) Pub. Date: Nov. 30, 2023

(54) SYSTEMS AND METHODS FOR ROUTING REMOTE APPLICATION DATA

(71) Applicant: Citrix Systems, Inc., Fort Lauderdale, FL (US)

(72) Inventors: Praveen Kumar Venkatesh, Bengaluru (IN); Yajat Sharma, Bengaluru (IN); Hitendra Thakkar, Bengaluru (IN); Ajay Baglodi, Bengaluru (IN)

(21) Appl. No.: 17/841,366

(22) Filed: Jun. 15, 2022

Related U.S. Application Data
(60) Provisional application No. 63/347,202, filed on May 31, 2022.

(51) Int. Cl. H04L 67/141; H04L 12/46; H04L 12/66; H04L 61/5007; H04L 61/3015

(52) U.S. Cl. CPC H04L 67/141; H04L 12/4633; H04L 12/66; H04L 61/5007; H04L 61/3025

(57) ABSTRACT

Systems and methods for a tunnel service to receive a request from the cloud service to establish a connection with an endpoint. The tunnel service transmits an address of the tunnel service to a gateway service to cause the gateway service to forward the address to a connector of the data center. The tunnel service receives, from the connector responsive to the connector receiving the address, a connection request for the connection. The tunnel service establishes the connection between the endpoint and the tunnel service.

### CROSS-REFERENCE TO RELATED PATENT APPLICATIONS

This application claims the benefit of and priority to U.S. Provisional Patent Application No. 63/347,202, filed May 31, 2022, the contents of which are incorporated herein by reference in its entirety.

### FIELD OF THE DISCLOSURE

The present application generally relates to computers and networking systems. In particular, the present application relates to systems and methods for improved routing data to and from endpoints.

### BACKGROUND

Various network applications may require connectivity across multiple network domains. Connectivity across multiple networks may involve interoperability and security concerns.

### BRIEF SUMMARY

Systems and methods described herein may provide solutions to transparently intercept and tunnel cloud traffic originating from a network to resources located at an on-premise data center. Some resources (such as adaptive authentication or other cloud-based resources) may be cloud-based, such that clients access on-premise resources through a cloud-based application or virtualized environment. For some cloud resources or services, the service may establish a connection from the cloud environment to the on-premise data center. Enterprises typically use various approaches to establish such connections from resources in a cloud subscription to the enterprise data center. These approaches may include a cloud virtual private network (VPN) service to a node disposed along a boundary of a network, which is disposed proximal to a first set of security measures and distal to a second set of security measures of the boundary, such as in the case of a network demilitarized zone, DMZ (e.g., IPSec). These approaches also include dedicated line solutions. For example, a private line may be established wherein a physical connectivity between two network nodes is owned or exclusive accessibility thereof is otherwise ensured (e.g., a private leased line), or wherein a dedicated line is semi-private, such as a fractionally owned line, or a service limiting a number of entities accessing the line, such as AZURE ExpressRoute or AMAZON WEB SERVICE (AWS) Direct Connect. Where subscription-based resources are hosted and accessible in a virtualized environment, additional services may be needed, such as Azure VNet peering or IPSec tunnel, to establish a connection between a virtualized managed network and enterprise managed network. Some challenges with implementing these additional services include complex setup and maintenance, as multiple components and/or cloud services are needed to implement solutions which directly translate to increased costs, security team approvals may be needed for terminating IPSec connections from the virtualized environment to the data center, and there may be a need for additional ingress firewalls at the data center-side.

According to the systems and methods of the present solution, a tunnel service may establish a connection (e.g., at an application level) between an endpoint disposed within a data center and another network node disposed outside of the data center, such as via a gateway and connector configured to establish connections therewith (e.g., establishing an L7 tunnel from the cloud to the customer data center via a cloud connector), and thereby avoid problems relating to direct reachability from the virtualized environment to the on-premise data center via Azure VNet peering, IPSec tunnels or MPLS/VPN solutions. This is done by establishing an application (e.g., L7) tunnel from a cloud to a customer data center via Citrix Cloud Connector. The systems and methods described herein may provide a cost-effective solution, especially for customers or enterprises that do not have a cloud presence, as such customers would not need to subscribe for additional cloud provider services apart from their specific cloud service subscriptions. The systems and methods described herein may provide a simple setup and almost zero touch. Additionally, since connections originate from within the customer data center towards the tunnel service, there would be no need for any changes to existing ingress firewalls (on the data center-side). The tunnels or connections established between the cloud service and tunnel service may provide an end-to-end tunnel encryption using transport layer security (TLS). The systems and methods escribed herein may provide a generic solution which can be used for any service which is cloud-based that may use on-premise resources (e.g., either as an external component in the network infrastructure or an internal component for services which use intermediary devices for application delivery).

Network administrators may balance the accessibility of resources on a network with a security and reliability of that network. For example, a plurality of networks may require interconnectivity between a network hosting data and a network accessing that data. Although various authentication methods may be employed, many network security measures may be bypassed by methods which may not become evident until years following their discovery, if they ever become evident at all. Thus, many networks adopt a blacklist or whitelist approach, blocking addresses and ports that various suspect communications may be received on, or only allowing access at given addresses, ports, times, etc. Modern enterprises may frequently need to interoperate with various services, and various network ports, addresses, and times may need to be adjusted with relative frequency. In many instances, ports may be left open longer than is necessary, leading to security risks or closed before their need has ended, leading to accessibility risks. Even a perfectly managed network may require time and expense (e.g., which may detract resources, so as to negatively impact cost, security, or reliability).

According to the systems and methods of the present solution, a tunnel service connects to a remote network (e.g., based on a network rule permitting the tunnel service to connect, or based on an outbound connection request originating within the remote network). Rules based approaches may of the network may be specific to inbound and outbound connection requests. The tunnel service may thereafter forward requests from additional network nodes to the remote network via a gateway service, such that the remote network may prohibit all inbound requests, or all inbound requests associated with the tunnel service, which may increase the security of the network, and lower the maintenance operation of the network. For example, if various tunnel service compatible services change ports, addresses, etc., or if various services are added, the tunnel and the gateway may manage the new ports, addresses, locations, etc., and pass the provided or validated addresses to the remote network for connection via an outbound request from the remote network.

At least one aspect of this disclosure is directed to a method. The method includes receiving, by a tunnel service, a request from a cloud service to establish a connection with an endpoint. The method includes transmitting, by the tunnel service, an address of the tunnel service to a gateway service to cause the gateway service to forward the address to a connector of the data center. The method includes receiving, by the tunnel service, from the connector responsive to the connector receiving the address, a connection request for the connection. The method includes establishing, by the tunnel service, the connection between the endpoint and the tunnel service.

In some embodiments, receiving the request includes intercepting, by the tunnel service, the request from the cloud service. In some embodiments, the method further includes configuring the tunnel service on at least one of a server hosting the cloud service or a cloud-service side device, wherein receiving the request is responsive to the tunnel service being configured. In some embodiments, the address is a fully-qualified domain name of the tunnel service. In some embodiments, the connection includes an end-to-end tunnel between the endpoint and a server hosting the cloud service. In some embodiments, the method further includes transmitting, by the cloud service to the connector, an internet protocol (IP) address and port of the endpoint. In some embodiments, establishing the connection is responsive to the cloud service transmitting the IP address and port of the endpoint to the connector. In some embodiments, the connection request is an outbound connection request originating from the connector.

In some embodiments, the method further includes determining, by the tunnel service, that the connection request received from the connector corresponds to the request to establish the connection received from the cloud service and wherein establishing the connection is responsive to the determination. In some embodiments, determining that the connection request corresponds to the request to establish the connection includes receiving, by the tunnel service from the gateway service, a first identifier corresponding to the connection, and associating, by the tunnel service, the connection request received from the connector with the request to establish the connection based on the first identifier matching a second identifier included in the connection request.

Another aspect of this disclosure is directed to a system. The system includes a server hosting a cloud service, and a tunnel service deployed on at least one of the server or a cloud-service side device. The tunnel service is configured to receive a request from the cloud service to establish a connection with an endpoint. The tunnel service is configured to transmit an address of the tunnel service to a gateway service to cause the gateway service to forward the address to a connector of the data center. The tunnel service is configured to receive, from the connector responsive to the connector receiving the address, a connection request for the connection. The tunnel service is configured to establish the connection between the endpoint and the tunnel service.

In some embodiments, the tunnel service is configured to receive the request by intercepting the request from the cloud service. In some embodiments, the address is a fully-qualified domain name of the tunnel service. In some embodiments, the connection includes an end-to-end tunnel between the endpoint and a server hosting the cloud service. In some embodiments, the cloud service is configured to transmit, to the connector, an internet protocol (IP) address and port of the endpoint. In some embodiments, establishing the connection is responsive to the cloud service transmitting the IP address and port of the endpoint to the connector. In some embodiments, the connection request is an outbound connection request originating from the connector. In some embodiments, the tunnel service is configured to determine that the connection request received from the connector corresponds to the request to establish the connection received from the cloud service, and wherein establishing the connection is responsive to the determination. In some embodiments, to determine that the connection request corresponds to the request to establish the connection, the tunnel service is configured to receive, from the gateway service, a first identifier corresponding to the connection, and associate the connection request received from the connector with the request to establish the connection based on the first identifier matching a second identifier included in the connection request.

Yet another aspect of this disclosure is directed to a non-transitory computer-readable medium storing instructions that, when executed by one or more processors, cause the one or more processors to receive a request from a cloud service to establish a connection with an endpoint. The computer-readable medium further stores instructions that cause the one or more processors to transmit an address of the tunnel service to a gateway service to cause the gateway service to forward the address to a connector of the data center. The computer-readable medium further stores instructions that cause the one or more processors to receive, from the connector responsive to the connector receiving the address, a connection request for the connection. The computer-readable medium further stores instructions that cause the one or more processors to establish the connection between the endpoint and the tunnel service.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device;

FIG. 1B is a block diagram depicting a computing environment including a client device in communication with cloud service providers;

FIG. 2A is a block diagram of an example system in which resource management services may manage and streamline access by clients to resource feeds (via one or more gateway services) and/or software-as-a-service (SaaS) applications;

FIG. 2B is a block diagram showing an example implementation of the system shown in FIG. 2A in which various resource management services as well as a gateway service are located within a cloud computing environment;

FIG. 2C is a block diagram similar to that shown in FIG. 2B but in which the available resources are represented by a single box labeled “systems of record,” and further in which several different services are included among the resource management services;

FIG. 3 is a block diagram of a cross network interface system in accordance with an illustrative embodiment;

FIG. 4 is another a block diagram of a cross network interface system in accordance with an illustrative embodiment;

FIG. 5 is a sequential diagram of a flow of data within the cross network interface system of FIG. 3 in accordance with an illustrative embodiment;

FIG. 6 is a diagram of a method for establishing connectivity across networks.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Systems and methods described herein may provide solutions to transparently intercept and tunnel cloud traffic originating from a network to resources located at an on-premise data center. Some resources (such as adaptive authentication or other cloud-based resources) may be cloud-based, such that clients access on-premise resources through a cloud-based application or virtualized environment. For some cloud resources or services, the service may establish a connection from the cloud environment to the on-premise data center. Enterprises typically use various approaches to establish such connections from resources in a cloud subscription to the enterprise data center. These approaches may include a cloud virtual private network (VPN) service to a node disposed along a boundary of a network, which is disposed proximal to a first set of security measures and distal to a second set of security measures of the boundary, such as in the case of a network demilitarized zone, DMZ (e.g., IPSec). These approaches also include dedicated line solutions. For example, a private line may be established wherein a physical connectivity between two network nodes is owned or exclusive accessibility thereof is otherwise ensured (e.g., a private leased line), or wherein a dedicated line is semi-private, such as a fractionally owned line, or a service limiting a number of entities accessing the line, such as Azure ExpressRoute or AWS Direct Connect. Where subscription-based resources are hosted and accessible in a virtualized environment, additional services may be needed, such as Azure VNet peering or IPSec tunnel, to establish a connection between a virtualized managed network and enterprise managed network. Some challenges with implementing these additional services include complex setup and maintenance, as multiple components and/or cloud services are needed to implement solutions which directly translate to increased costs, security team approvals may be needed for terminating IPSec connections from the virtualized environment to the data center, and there may be a need for additional ingress firewalls at the data center-side.

According to the systems and methods of the present solution, a tunnel service may establish a connection (e.g., at an application level) between an endpoint disposed within a data center and another network node disposed outside of the data center, such as via a gateway and connector configured to establish connections therewith (e.g., establishing an L7 tunnel from the cloud to the customer data center via a cloud connector), and thereby avoid problems relating to direct reachability from the virtualized environment to the on-premise data center via Azure VNet peering, IPSec tunnels or MPLS/VPN solutions. This is done by establishing an application (e.g., L7) tunnel from a cloud to a customer data center via Citrix Cloud Connector. The systems and methods described herein may provide a cost-effective solution, especially for customers or enterprises that do not have a cloud presence, as such customers would not need to subscribe for additional cloud provider services apart from their specific cloud service subscriptions. The systems and methods described herein may provide a simple setup and almost zero touch. Additionally, since connections originate from within the customer data center towards the tunnel service, there would be no need for any changes to existing ingress firewalls (on the data center-side). The tunnels or connections established between the cloud service and tunnel service may provide an end-to-end tunnel encryption using transport layer security (TLS). The systems and methods escribed herein may provide a generic solution which can be used for any service which is cloud-based that may use on-premise resources (e.g., either as an external component in the network infrastructure or an internal component for services which use intermediary devices for application delivery).

Network administrators may balance the accessibility of resources on a network with a security and reliability of that network. For example, a plurality of networks may require interconnectivity between a network hosting data and a network accessing that data. Although various authentication methods may be employed, many network security measures may be bypassed by methods which may not become evident until years following their discovery, if they ever become evident at all. Thus, many networks adopt a blacklist or whitelist approach, blocking addresses and ports that various suspect communications may be received on, or only allowing access at given addresses, ports, times, etc. Modern enterprises may frequently need to interoperate with various services, and various network ports, addresses, and times may need to be adjusted with relative frequency. In many instances, ports may be left open longer than is necessary, leading to security risks or closed before their need has ended, leading to accessibility risks. Even a perfectly managed network may require time and expense (e.g., which may detract resources, so as to negatively impact cost, security, or reliability). For purposes of reading the description of the various embodiments below, the following descriptions of the sections of the specification and their respective contents may be helpful:

Section A describes a computing environment which may be useful for practicing embodiments described herein;

Section B describes resource management services for managing and streamlining access by clients to resource feeds;

Section C describes systems and methods for routing remote application data; and

Section D describes various example embodiments of the systems and methods described herein.

### A. Computing Environment

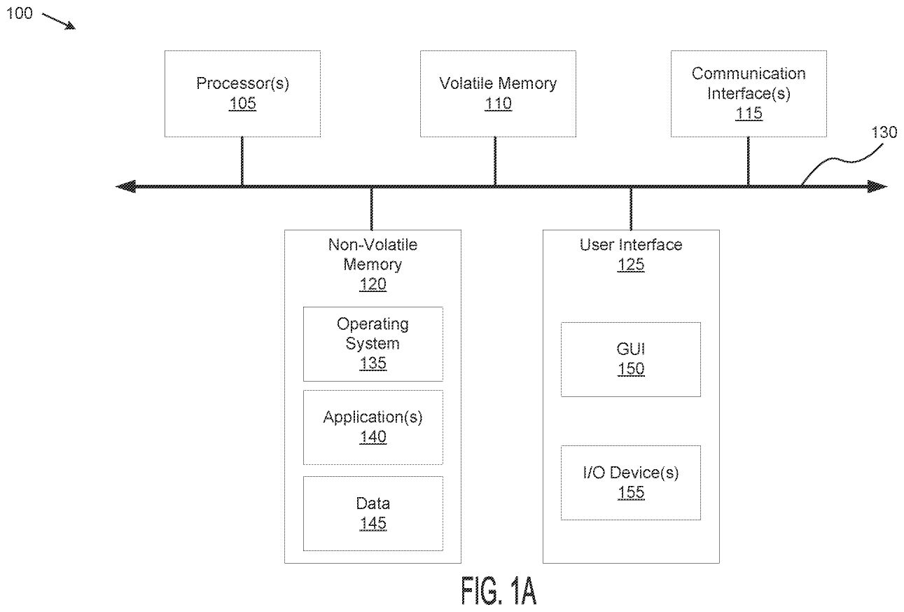

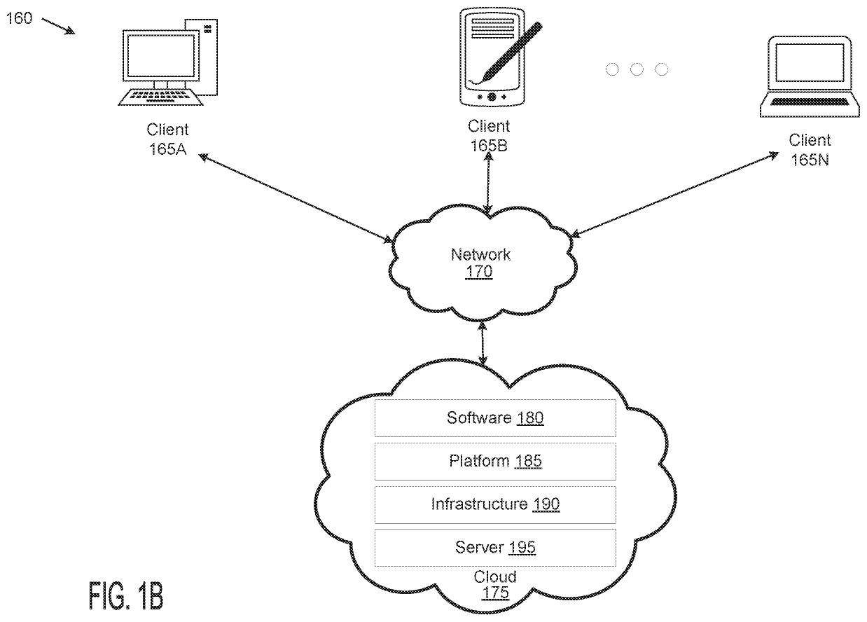

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computer 100 may execute an application on behalf of a user of a client computing device. For example, the computer 100 may execute a virtual machine, which provides an execution session within which applications execute on behalf of a user or a client computing device, such as a hosted desktop session. The computer 100 may also execute a terminal services session to provide a hosted desktop environment. The computer 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 160 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms, or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Resource Management Services for Managing and Streamlining Access by Clients to Resource Feeds

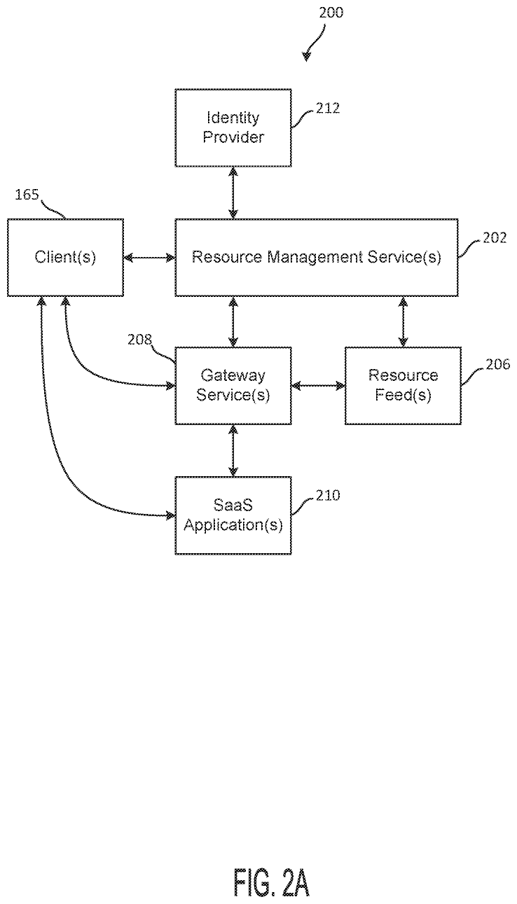

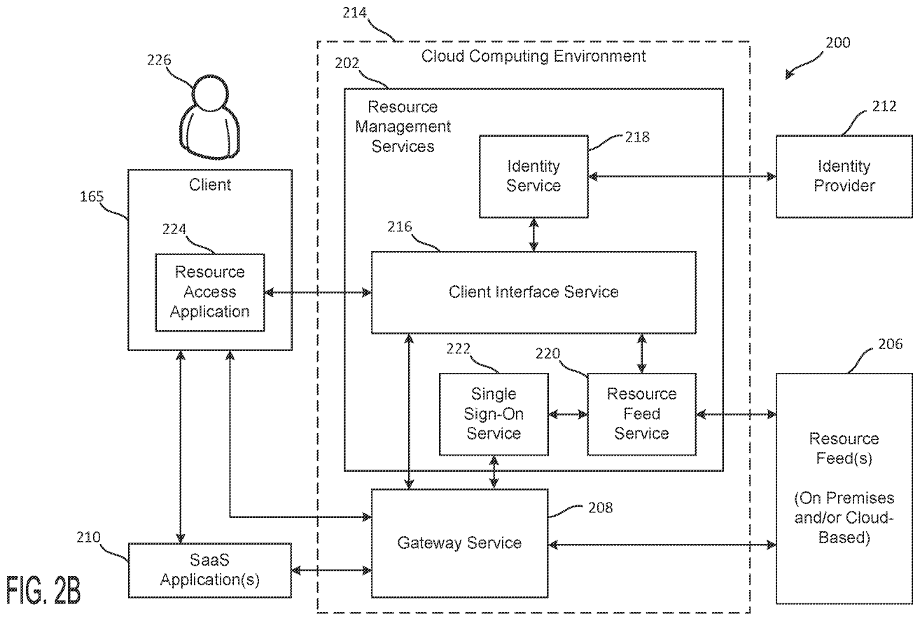

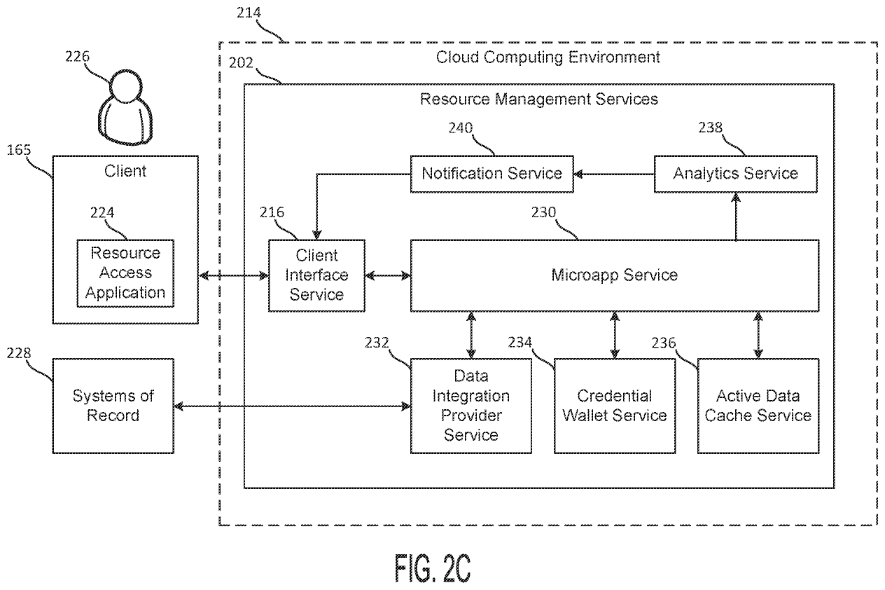

FIG. 2A is a block diagram of an example system 200 in which one or more resource management services 202 may manage and streamline access by one or more clients 165 to one or more resource feeds 206 (via one or more gateway services 208) and/or one or more SaaS applications 210. In particular, the resource management service(s) 202 may employ an identity provider 212 to authenticate the identity of either end-users, which use a client 165, or the appliances themselves. Following authentication, the resource management service(s) 202 can identify one of more resources for which the user has authorization to access. For example, the resource management service(s) can identify that client 165A has authorization to access the resource feed related to DNS multipath routing whereas client 165B is not (e.g., client 165B is not licensed for a feature; client 165B is not multipath capable, etc.). In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 165 may be any type of computing devices capable of accessing the resource feed(s) 206 and/or the SaaS application(s) 210, and may, for example, include a variety of desktop or laptop computers, smartphones, tablets, and network appliances such as routers and firewalls. The resource feed(s) 206 may include any of numerous resource types and may be provided from any of numerous locations. In some embodiments, for example, the resource feed(s) 206 may include one or more systems or services for providing virtual applications and/or desktops to the client(s) 165, one or more file repositories and/or file sharing systems, one or more secure browser services, one or more access control services for the SaaS applications 210, one or more management services for local applications on the client(s) 165, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud-computing environment may, for example, include MICROSOFT AZURE Cloud, AMAZON Web Services, GOOGLE Cloud, or IBM Cloud.

For any of illustrated components (other than the client 165) that are not based within the cloud computing environment 214, cloud connectors (not shown in FIG. 2B) may be used to interface those components with the cloud computing environment 214. Such cloud connectors may, for example, execute on WINDOWS Server instances hosted in resource locations, and may create a reverse proxy to route traffic between the site(s) and the cloud-computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data deployed across multiple locations for geo-redundancy.

When the resource access application 224 is launched or otherwise accessed by a respective client 165, the client interface service 216 may send a sign-on request to the identity service 218. In some embodiments, the identity provider 212 may be located on the premises of the organization for which the system 200 is deployed. The identity provider 212 may, for example, correspond to an on-premises WINDOWS Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user's authentication credentials (e.g., user-name and password). Upon receiving the user's authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user's identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a MICROSOFT AZURE Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user's authentication credentials. Upon determining the user's identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user's identity has been properly authenticated, the client interface service 216 may send a request to the resource feed service 220 for a list of subscribed resources for the user 226.

For the configured resource feeds, the resource feed service 220 may request an identity token from the single sign-on service 222. The resource feed service 220 may then pass the feed-specific identity tokens it receives to the points of authentication for the respective resource feeds 206. The resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more interne enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource access application 224 is located remotely) (e.g., via a secure browser service). In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access (e.g., by disabling cut/copy/paste operations between the application and the clipboard), (3) restricting printing (e.g., by disabling the ability to print from within the browser), (3) restricting navigation (e.g., by disabling the next and/or back browser buttons), (4) restricting downloads (e.g., by disabling the ability to download from within the SaaS application), and (5) displaying watermarks (e.g., by overlaying a screen-based watermark showing the username and IP address associated with the client 165 such that the watermark will appear as displayed on the screen if the user tries to print or take a screenshot). Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements (e.g., “approve,” “deny,” and “see more detail” buttons), allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 165 to notify a user 226 of something that requires the user's attention (e.g., approval of an expense report, new course available for registration, etc.).

FIG. 2C is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 2C may enable the provision of a streamlined resource activity feed and/or notification process for a client 165. In the example shown, in addition to the client interface service 216 discussed above, the illustrated services include a microapp service 230, a data integration provider service 232, a credential wallet service 234, an active data cache service 236, an analytics service 238, and a notification service 240. In various embodiments, the services shown in FIG. 2C may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or homegrown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 2C may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud-computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 2C, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the credential wallet service 234 may store encrypted service credentials for the systems of record 228 and user OAuth2 tokens.

In some embodiments, the data integration provider service 232 may interact with the systems of record 228 to decrypt end-user credentials and write back actions to the systems of record 228 under the identity of the end-user. The write-back actions may, for example, utilize a user's actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

Finally, in some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the credential wallet service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the credential wallet service 234 an encrypted OAuth2 token for the system of record for which the action is to be invoked, and may send the action to the data integration provider service 232 together with the encrypted OAuth2 token. The data integration provider service 232 may then decrypt the OAuth2 token and write the action to the appropriate system of record under the identity of the user 226. The data integration provider service 232 may then read back changed data from the written-to system of record and send that changed data to the microapp service 230. The microapp service 230 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 202 may, for example, parse these requests and respond because they are integrated with multiple systems on the back-end. In some embodiments, users may be able to interact with the virtual assistance functionality either through the resource access application 224 or directly from another resource, such as Microsoft Teams. This feature may allow employees to work efficiently, stay organized, and deliver only the specific information they are looking for.

### C. Systems and Methods for Routing Remote Application Data

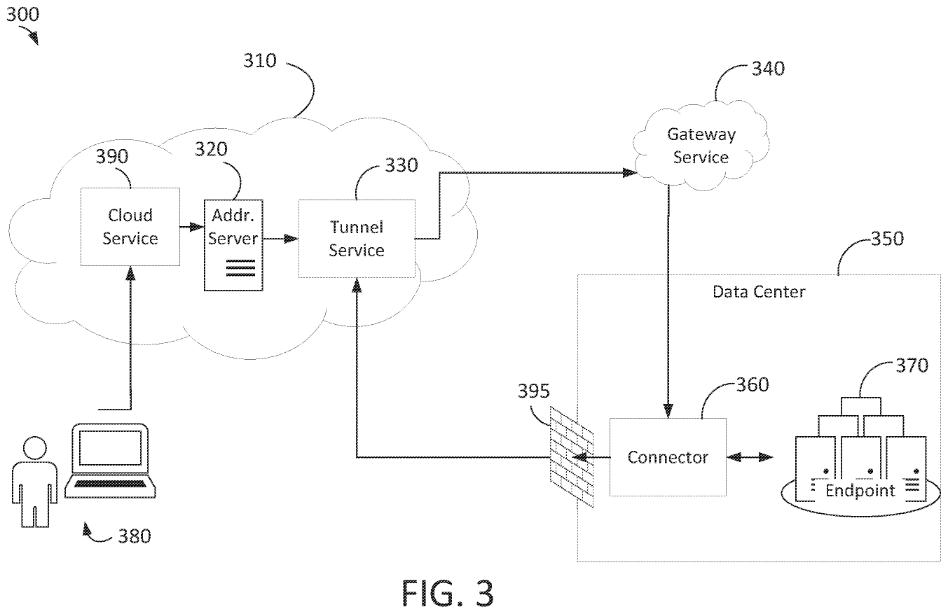

As shown in FIG. 3, the cross network interface system 300 may include a tunnel cloud 310 including an addressable server 320 and tunnel service 330, a gateway service 340, a data center 350 including a connector 360 and endpoint 370, and a terminal 380 (e.g., a client, client device, etc.). As described in greater detail below, the tunnel cloud 310 may further include a cloud service 390, which may generate requests or receive requests from additional network nodes, or may be configured to receive a request from a cloud service 390 to establish a connection with an endpoint 370 of a data center 350. The tunnel cloud 310 may be further configured to transmit an address of the tunnel service 330 to a gateway service 340 to cause the gateway service 340 to forward the address to a connector 360 of the data center 350. The tunnel cloud 310 may be further configured to receive from the connector 360, responsive to the connector receiving the address, a connection request for the connection. The tunnel cloud 310 may be further configured to establish the connection between the endpoint 370 and the tunnel service 330.

A block diagram of a cross network interface system 300 in accordance with an illustrative embodiment is disclosed. As shown in FIG. 3, various nodes may be aggregated into one or more networks. Each network or node may have an associated set of access controls for interfacing with additional network elements or nodes. For example, each node may permit or deny connections or messages based on an address of a sending device (e.g., IP address, MAC address, application level address), a port, a message a connection request is presented to, characteristics of a request such as a request size, a request type, or a request time, etc. The one or more networks may form nested networks, such that various nodes may be disposed within a plurality of networks having various controls to communicate therebetween.

The cross network interface system 300 may include an addressable server 320, and a tunnel service 330 which may be referred to collectively, as a tunnel cloud 310. The tunnel cloud 310 can receive requests associated with a resource of another network node (e.g., an endpoint 370, a terminal 380, a cloud service 390, etc.). For example, the requests may be a request for a resource. The tunnel cloud 310 may examine the content of the request, such as the destination address, the content of the request, and the source information. According to various embodiments, the tunnel cloud 310 may respond to a request directly (e.g., for a resource hosted by the tunnel cloud 310), or provide a response (e.g., in response to an invalid message type). Some messages may be gated/firewalled by the tunnel cloud 310 (e.g., in response to a request type, a credential, etc.). Some messages may be passed to another network node such as a gateway service 340. For example, the message may be forwarded as received (e.g., containing additional header or footer information around an encrypted message), or the tunnel cloud 310 may forward the message by generating a second message based on the received message. For example, if a message includes a request or an identifier such as a key, credential, token, etc., the tunnel cloud 310 may generate a message including the identifier, or verifying receipt of the identifier (e.g., a flag bit, a private key, etc.), which may also be referred to herein as forwarding the message/request, conveying the message/request, transmitting the message/request, etc.

The addressable server 320 may be or include any device, component, element, processor, computer, or other various combinations of hardware configured to be communicatively coupled with additional network nodes, such as to send and receive messages. The addressable server 320 can provide a first plurality of resources hosted on the addressable server 320, a second set of resources from a first endpoint 370 of a first data center 350, a second endpoint 370 of the first data center 350, a first endpoint 370 of a second data center 350, etc. The addressable server 320 can provide the resources responsive to a request (e.g., a message). For example, the addressable server 320 can receive the request from a terminal 380, a gateway service 340, an endpoint 370 such as an endpoint 370 of a data center 350, a tunnel service 330, etc. The addressable server 320 can forward the requests to one or more addresses. For example, the addressable server 320 can address various messages, replies, requests, responses, etc. to various endpoints 370, gateway service 340, or other network nodes. In some implementations, the address information associated with the tunnel service 330 may be an address of another network node that is serviced by the tunnel service 330. In some embodiments, the request which is addressed to another network node may be intercepted by the tunnel service 330. An indication of the interception may be received by the addressable server 320 or the interception may be transparent to the addressable server 320.

The tunnel service 330 may be or include any device, component, element, processor, computer, or other various combinations of hardware configured to communicate with additional network nodes, such as the addressable server 320, the gateways service 340, or other components, elements, or devices within the system 300. In some embodiments, the tunnel service 330 may share one or more components with the addressable server 320 or another network node. For example, the tunnel service 330 and the addressable server 320 may share a memory whereby messages can be passed at least from the addressable server 320 to the tunnel service 330. The tunnel service 330 may receive, identify, detect, inspect, or intercept messages from the addressable server (e.g., via a network message, through a shared memory, through a peer to peer link, etc.). The tunnel service 330 may be configured to inspect various messages sent by the addressable server 320. For example, the tunnel service 330 may be configured to determine a message is addressed to the addressable server 320, or another network node, and may further be configured to determine if a message is directed to a first network node, a network node within a pre-defined range, etc. For example, the tunnel service 330 may be configured to inspect various headers, perform deep packet inspection, etc. to determine an address, an endpoint 370, or another destination associated with the message.

The tunnel service 330 may also be communicatively coupled with one or more gateway services 340 or other resources. For example, the tunnel service 330 may be communicatively coupled to a first gateway service 340 associated with a first endpoint 370 of a first data center 350, with a second endpoint 370 of a second data center 350, etc. The tunnel service 330 may also include, maintain, or otherwise access one or more lookup tables or other lookup information to correlate the one or more messages to one or more additional network devices (e.g., one or more endpoints 370, addressable servers 320, gateway services 340, etc.) The tunnel service 330 can include one or more identifiers, or hardware configured to generate one or more identifiers as will be described herein. Indeed, each of the various network nodes may include, maintain, or otherwise access an identifier or an ability to generate an identifier, which may be used by the tunnel service 330 and various additional network nodes to determine an address, verify an identity, encrypt or decrypt information, validate an association between devices or messages, etc.

The gateway service 340 may be or include any device, component, element, processor, computer, or other various combinations of hardware which is communicatively coupled with a connector 360 of a secure network, and the tunnel cloud 310. For example, the gateway service 340 may be configured to receive messages from the tunnel cloud 310. The gateway service 340 may include elements to evaluate received messages to determine an authenticity of a message (e.g., due to an identifier such as a sequenced number, a cryptographic key or signature, etc.). The gateway service 340 may include various filtering components for messages received over the various connections. For example, the gateway service 340 may be configured to inspect incoming messages and determine a disposition based on the message. For example, the gateway service 340 may be configured to discriminate between authorized and unauthorized traffic, traffic intended for transmission to a first data center 350, a second data center 350, a first connector 360, a second connector 360, etc.

The data center 350 may be or include any device, component, element, processor, computer, or other various combinations of hardware which may include a connector 360, which is communicatively coupled with an endpoint 370 having a resource. In some instances, the data center 350 may be bounded by at least one firewall 395, or the like (e.g., may include one or more filtering or inspection technologies). The firewall 395 may include or define a set of rules are associated with the data center 350 to control the flow of various messages, data, etc. For example, the data center 350 may impose limits of inter-device communication based on addresses or address ranges, ports, destinations, hop counts, etc.

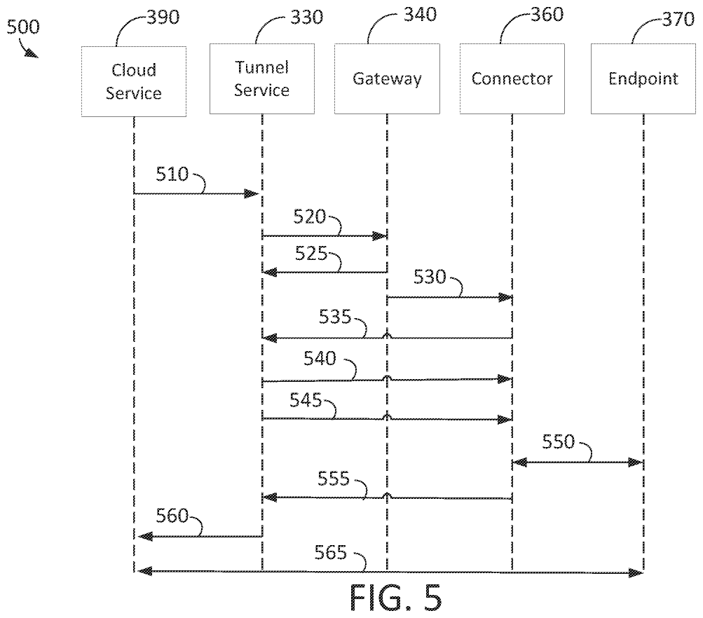

The connector 360 may be or include any device, component, element, processor, computer, or other various combinations of hardware configured to pass information between the endpoint 370 and the tunnel cloud 310 over an established connection, or incident to establishing a connection, as is further detailed by FIG. 5 and the description thereof. For example, the connector can initiate outbound requests for connection and at least thereafter receive data over the established connection. The connector 360 can host various connections such that the connector 360 manages a first connection with the endpoint 370 and a second connection to another network node. The connector 360 may monitor the various managed connections (e.g., in an active mode). The connector 360 can pass various connections to the endpoint 370 or the connecting nodes residing outside of the data center 350. For example, the connector 360 can establish a secure connection (e.g., end to end encrypted between the endpoint 370 and the other network node, or can establish a secure connection between the endpoint 370 and the other network node that the connector can monitor the connection, such as in a passive mode). The connector is communicatively coupled with the gateway device to at least receive messages from the gateway service 340.

The connector 360 may be configured to connect to one or more gateway services 340, such as based on a configuration file. For example, the connection may be based on an outbound request by the data center 350, or the connector 360 may register with the gateway service 340 as a device to allow inbound connections. Such a configuration may enable a connection without receiving an inbound request from the gateway service 340. In some embodiments, a data center 350 may not permit any inbound requests (or limited inbound request). For example, all connections may be initiated based on an outbound request, or all connections to non-registered device may be initiated based on an outbound request.

The endpoint 370 may be or include any device, component, element, processor, computer, or other various combinations of hardware configured to host a resource, which is accessible over a network connection. The endpoint 370 may include a web-based application, a security credential, a file, a streaming video, etc. In some embodiments, the endpoint 370 may be defined based solely on the content of an incoming messages. In some embodiments, the endpoint 370 may be defined by further criteria. For example, the endpoint 370 may be defined based on an available load, (e.g., for load sharing), a desired service level, a regulatory rule (e.g., a data flow including collecting or storing information within a particular geographic region), etc. The endpoint 370 may host a service directly, or may be a proxy, router, etc. For example, the endpoint 370 may host the resource based on additional connections to additional network nodes (e.g., the resource may be a resource of a content delivery network CDN).

A terminal 380 may be or include any device, component, element, processor, computer, or other various combinations of hardware configured to receive an input from a user (e.g., a human user, another network node, a service, a micro-service, etc.). In some embodiments, the terminal 380 may be a process hosted by a cloud service 390, or another network node. The terminal 380 is configured to access the cloud service 390 or the addressable server 320. For example, the terminal 380 may access the cloud service 390 via a web browser.

The cloud service 390, may be or include any device, component, element, processor, computer, or other various combinations of hardware configured to be accessible via a terminal 380. For example, the cloud service 390 may be a service requiring a license, or another network resource requiring authentication. The cloud service 390 may share components such as memories and processor with the cloud tunnel. For example, the cloud service 390, the addressable server 320, and the tunnel service 330 may share a processor and at least one memory space (e.g., a memory space to share data, or executable instructions thereof). Alternatively or in addition, the cloud service 390, the addressable server 320, and the tunnel service 330 may include independent processors and memory spaces therefor, and may communicate over a transmission line. The cloud service 390, like the other network nodes depicted herein, may communicate over a local access network, a wide access network including the internet, or one or more peer to peer connections. For example, the cloud service 390 may communicate with the addressable server 320 via shared memory or other communication channels (e.g., communications channels within the tunnel cloud 310).

The firewall 395 may be or include any device, component, element, processor, computer, or other various combinations of hardware configured to analyze messages at a network interface to selectively pass the messages through the interface. The firewall 395 may be configured with rules permitting or denying access. Some firewalls 395 may implement restrictive or permissive rules. For example, a restrictive rule may block traffic on a specified port. A permissive rule may to permit a certain address range. Firewalls may also have default restrictive or permissive access. For example, a firewall may permit all messages that do not correspond to a rule, or restrict all messages that do not correspond to a rule. Various rules may be layered or nested. For example, a firewall may have default restrictive access (e.g., no message are allowed . . . ), with first a permissive rule (e.g., . . . unless the messages originate in a 10.1.1.XXX address range), and second restrictive rule ( . . . however, messages in the allowable range cannot connect over port 80 or 443, or cannot be inbound messages). Various combinations of restrictive and permissive rules may be implemented according to a desired application. Although pictured along a boundary of the data center, firewalls may be disposed at various network interfaces and between various devices. For example, each of the connections described herein may include a firewall along the connection.

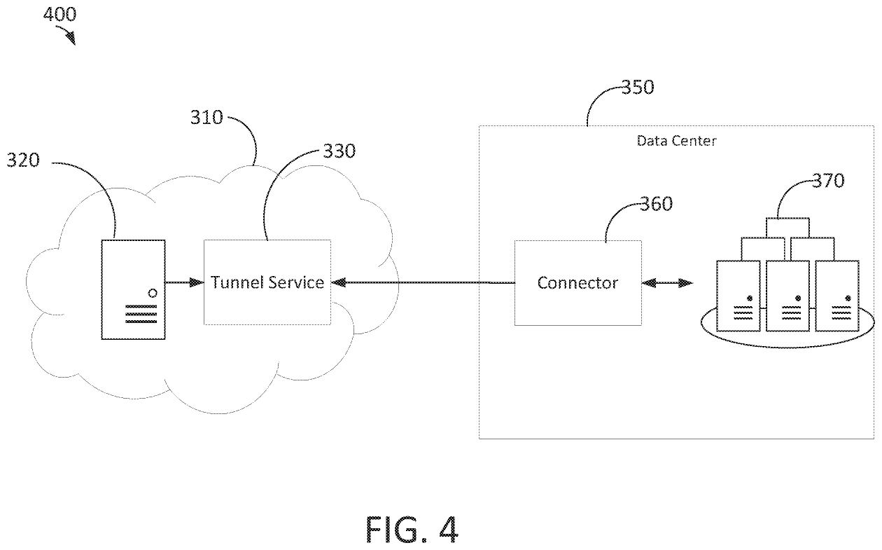

Referring now to FIG. 4, a block diagram of a cross network interface system 400 in accordance with an illustrative embodiment is depicted. The block diagram depicts the tunnel cloud 310 having an addressable server 320 and a tunnel service 330. A data center 350 is also depicted, having a connector 360 and a plurality of endpoints 370. The gateway service 340 of FIG. 3 is not depicted. The tunnel cloud 310 may be connected to the data center 350 (e.g., via the connector 360 by a TLS secured connection over the internet). For example, the data center 350 may initiate the connection (e.g., in response to a configuration file or setting, a message received over a connection established via an outbound connection, or a message received over a permitted inbound connection (not depicted)). For example, the tunnel service 330 or another device may be registered with the data center 350.

Alternatively or in addition, cross network interface system 400 may depict the state of network connections following the establishment of a connection, by the gateway device of FIG. 3. For example, the gateway service 340 may be offline (e.g., due to a network failure, a time of day limitation on establishing connections, maintenance, or update, etc.) A connection established prior to the unavailability of the gateway service 340 may be maintained. Advantageously, this may permit “hot swapping” of gateway services 340, increased reliability, and reduce routing needs to establish redundancy. Alternatively or in addition, the gateway service 340 may continue to operate, and may be logically excluded from a routing path. Advantageously, this may reduce a load on the gateway service 340, relative to some embodiments wherein the gateway service 340 continues to route or otherwise interface with connections established through the gateway service 340.

The addressable server 320 or the tunnel service 330 may connect to the data center 350 without receiving a message from a cloud service 390. For example, the addressable server 320 may receive a message from a terminal 380 or other network node, or may have one or more predefined or user initiated connection criteria (e.g., in response to a timer or another stimulus). In some implementations, the data center 350 may be configured to connect (e.g., periodically or continuously) to the gateway service 330, such as responsive to the registration of the connector to the gateway service.

Referring now to FIG. 5, a sequential diagram of a flow of data within the cross network interface system 300 in accordance with an illustrative embodiment. In brief summary, the cloud service 390 conveys a message to the tunnel service 330 at operation 510 whereupon the tunnel service 330 forwards a message to the gateway service 340 at operation 520. The gateway service 340 acknowledges receipt of a message at operation 525 and, at operation 530, conveys the message to the connector 360. At operation 535, the connector 360 conveys a connection request to the tunnel service 330. At operation 540, the tunnel service 330 verifies the connection with the connector 360. At operation 545, the tunnel service 330 releases an address such as a port an IP associated with the cloud service 390. At operation 550, the connector 360 opens a connection with the endpoint 370. At operation 555, the connector 360 verifies the establishment of the connection to the tunnel service 330. At operation 565, a connection between the cloud service 390 and the endpoint 370 is established. As discussed with regard to, for example, FIG. 3, the various messages, requests, and connections between various network nodes may be appended, encrypted, reformatted to add or subtract information, etc. For example, a message may be sent by the terminal 380, to a router whereupon the router may append the message with header information before forwarding the message to the cloud service 390. The various states of the message may be referred to herein as instances of a single message, or as a plurality of messages; either such term is not intended to be limiting.

The operations depicted in FIG. 5 may vary according to a configurable profile, a network technology, a particular cloud service 390 being accessed, etc. For example, the operations depicted in FIG. 5 may establish a TCP (e.g., for lightweight directory access protocol (LDAP)) or UDP connection (e.g., for remote authentication dial-in service (RADIUS)), or may depict an application level connection (e.g., the connection may be established at layer 7/L7 of the open systems interconnection (OSI) model.)In various embodiments, the method 500 may include additional or fewer operations. For example, additional or fewer acknowledgement requests may be included. Further, additional or fewer network nodes may perform the method. For example, a proxy may be inserted or substituted (e.g., for load balancing purposes, to implement security protocols, etc.). In some embodiments, the cloud service 390 forms a connection with the endpoint 370 or the addressable server 320 at operation 560, and thereafter, the endpoint may communicate with the cloud service 390 directly, or via the addressable server 320 (which may be a proxy for the cloud service 390 such that a logical connection may be present between the cloud service 390 and the endpoint 370). In some embodiments, one or more terminals 380 may convey messages to the tunnel service 330, such as to bypass the cloud service 390.

The message may be generated by the cloud service 390 or received from another network node. For example, the message may be generated by a terminal 380 (e.g., a terminal associated with a user) to access a resource from the cloud service 390. For example, the terminal 380 may send the cloud service 390 a message, such as a request to access a resource, or to initiate a connection. The resource may be a web-based application, a security credential, a file, a streaming video, etc. The access may be manually entered by a user, a process of the terminal programmed to access the cloud service 390 (e.g., at regular interval, in repose to stimulus, etc.). The request can include additional information such as a token, credential, authorization code, source address, etc. The additional information may be for the cloud service 390, or another network node. For example, a terminal 380 may provide a first identifier to the cloud service 390 to forward to another network node, or the terminal 380 may provide a first credential to the cloud service to authenticate the terminal 380, and the cloud service 390 may provide a second credential to an additional network node to obtain the resource.

At operation 510, the cloud service 390 conveys a message to the tunnel service 330, and may be responsive to another message received by the cloud service 390, or a process initiated by the cloud service 390. For example, the cloud service 390 may receive a request from various network nodes. The requests may be addressed or associated with various resources. For example, messages may be requests to public web pages, search engines, or resources such as DNS requests. The requests may be addressed to managed resources, such an authentication service, network access to a file or streaming service, etc. The cloud service 390 may identify various received messages associated with managed resources. For example, the cloud service 390 may associate various ports, networks or sub networks, message types, or signatures with a resource type. In some embodiments, the managed resources may be associated with a public resource and a managed resource. For example, the cloud service 390 may receive a message directed to a public DNS service, which the cloud service 390 may redirect to a managed resource (e.g., a managed resource that is different that the public resource). The cloud service 390 may direct messages to other than their addressed destinations in some embodiments. For example, a received message may be associated with an obsolete (e.g., decommissioned) network node. The cloud service 390 may recognize the network node based on an address, content, sender, etc., and direct the message to a replacement network node. Thus, replacement of various network addresses or assets may be managed by the cloud service 390, and a user of the web service may continue to operate absent updates. For example, the cloud service 390 can include a mapping table of redirects (e.g., due to transitioned applications or equipment, security concerns, etc.).

The messages may be sent to the tunnel service 330 by the cloud service 390. For example, tunnel service 330 may intercept messages from the cloud service 390. Any of the mapping table of redirects, defined subnets, services, or ports intended for redirection may be a portion of the tunnel service 330. For example, the tunnel service 330 may monitor the outbound traffic (or a memory space, etc.) of the cloud service 390, and redirect all or a subset of messages identified similarly as described by the cloud service 390, or the addressable server 320, above. For example, in some embodiments, forwarding the message to the tunnel service 330 may include forwarding the message to an address range, a protocol, a communications channel, etc. which is monitored by the tunnel service 330, such that the tunnel service 330 may intercept the message. For example, the tunnel service 330 may intercept the message from a transmission line, a shared memory device (e.g., random access memory, a register, etc.).

In some embodiments, various operations of the tunnel service 330, cloud service 390, and addressable server 320 may be substituted. For example, in some embodiments, the addressable server 320 may determine a message should be directed to one or more gateway services 340. In some instances, the tunnel service 330 may be directed, by the addressable server 320 or the cloud service 390, to pass the messages to the gateway service 340. In some embodiments, the addressable server 320 may route received messages according to their addressed recipients, and the cloud service 390 may thereafter inspect and redirect any portion of messages to be redirected. For example, the tunnel service may operate transparently to the cloud service 390. Thus, various operations depicted herein may be substituted between any of the cloud service 390, the addressable server 320, and the tunnel service 330.

At operation 520, the tunnel service 330 may direct a message to the gateway service 340. The tunnel service 330 may be associated with the message based on a resource, an address, an endpoint 370, etc. For example, the tunnel service 330 may be communicatively coupled to a plurality of gateway services 340 and a gateway service 340 may be selected based on the message. The message passed to the gateway service 340 may include one or more identifiers including a credential or another token. The identifiers may be associated or associable with the gateway service 340 such that the recipient of a message may verify the identity of the sending tunnel service 330, the terminal 380, etc. Alternatively or in addition, the identifier may be unique to the connection. For example, the identifier may be generated (e.g., randomly, sequentially, via concatenation of a plurality of fields, etc.) for a connection (e.g., by the terminal 380, the tunnel cloud 310, etc.). A receipt of the identifier, or a variant thereof may confirm that a connection request is responsive to the desired connection, and may further validate the identity of one or more network nodes (e.g., by encrypting the data using a public key of a public/private pair or another shared key including a symmetric key).

The message may include a fully qualified domain name (FQDN) or another domain name or address. The address may be of the terminal 380, the cloud service 390, or a proxy thereof. For example, the address may be the address of the cloud service 390 if the cloud service 390 is intended to be connected to the endpoint 370. The address may be the same address as the source address associated with the cloud service 390, or may be a different address. For example, the cloud service 390 may maintain an alias for first or second connections.

Alternatively or in addition, the tunnel service 330 may otherwise establish a tunnel with the data center 350. For example, as discussed with regard to FIG. 4, the tunnel service 330 may be registered with the data center 350 (e.g., a firewall 390 or connector 360 of the data center 350) to connect to the data center 350. In some embodiments the data center 350 may be configured to connect to the tunnel service 330 (e.g., periodically to pull data such as one or more connection requests from the tunnel service 330). In some embodiments, a first tunnel may be formed between the tunnel service 330 and the data center 350, and a plurality of connections (e.g., second tunnels) may be formed between one or more network nodes and the data center, based on the first tunnel. The first tunnel may be formed based on a registration of the tunnel connector 330, a connection established with a data center 350 based on a message conveyed to the data center 350 from a gateway service 340, or otherwise, as is described herein.

At operation 525, the gateway service 340 acknowledges the receipt of the message. Acknowledgement may include a validation of one or more identifiers received by the gateway service 340. For example, the validation may validate that an identifier is received, is authorized to use the gateway service, is unique, is an expected sequence, contains expected content, etc. The acknowledgement may further include an indication that the gateway service 340 is communicatively coupled to a connector 360 capable of receipt of the desired communication, incapable of the desired communication, requires additional information to convey the message to a connector, etc. In some embodiments, the acknowledgement may include an error code indicating a validation status code (e.g., CRC check, configuration data for configuration of a gateway service 340, an unknown resource type, etc.).

At operation 530, the gateway service 340 directs the message to the data center 350. For example, the gateway service 340 may direct the message to the connector 360. The gateway service 340 may select the connector 360 based on the content of the data. If the gateway service 340 is unable to locate an appropriate connector 360, the gateway service 340 may broadcast either of a request for an address to the connector 360 or the message for transmission to the connector 360. One or more identifiers may be passed with or as a portion of the message, such that the source address or identity may be known, verified, validated, etc. upon the receipt of the message by the connector 360.

At operation 535, the connector 360 sends an outbound request to the tunnel service 330. The outbound connection may include one or more identifiers. For example, the outbound connection may include the identifier of the cloud service or another network node to be connected. For example, the identifier may be an address or a token which is unique to the connection request, to the device, etc.

At operation 540, the tunnel service 330 or another network node verifies a receipt of the outbound request. For example, the verification may indicate a success or failure of the connection, the one or more identifiers, etc. In some embodiments, this or other transmissions may be further based on a timeout, and the verification may further verify the non-expiration of a timer associated with the timeout. At operation 545, the connected node such as the tunnel service 330 releases connection information (e.g., an IP and port) to the connector 360. The connection information may be for a network node desiring connection, such as a cloud service 390, a terminal 380, etc. The release of the connection information may be communicated to the connector 360 (e.g., in the same message as the verification, a different message, or the connection information may be retained by the connector 360 and may not be conveyed). For example, the connection information may be pre-defined or communicated during another operation (e.g., in a message sent at operation 510). The IP and port may be opened for a limited time. For example, the IP and port may be opened for 500 ms, 1 second, or 1 minute (e.g., beginning upon sending the initial message, upon receiving the outbound request, another time, or at an offset of an event). In some embodiments, the release of the connection information may be responsive to the presentation of an identifier that verifies that the connector received the message originating from the cloud service 390, the tunnel service 330, etc. For example, a token originating from the cloud service 390 may be returned to the cloud service 390 (e.g., in an original form, or encrypted/signed based on a key or identifier held by the cloud service 390 or another device).

At operation 550, the connector 360 establishes a connection with the endpoint 370. The connector may convey one or more identifiers (e.g., IP address, port, etc.) to the endpoint 370 or to a connecting network node such as the cloud service 390. At operation 555, the endpoint 370 conveys the establishment of this connection to the connecting network node and may link the connection to the endpoint 370. Operation 555 may include permitting the traffic through a firewall 395 associated with the data center 350. Indeed, various operations disclosed herein may require adjusting various access permissions, routes, whitelists or blacklists, etc.

At operation 565, the endpoint 370 and the cloud service 390 or other node are connected such that information may be sent to or retrieved from the endpoint 370. The connection may be a direct connection or may include one or more additional connection legs. For example, the addressable server 320 or another proxy, intermediary, or gateway may host or manage the connection with the cloud service 390 or other connecting node. In some embodiments, the cloud service 390 or another network node can host the connection for the terminal 380.

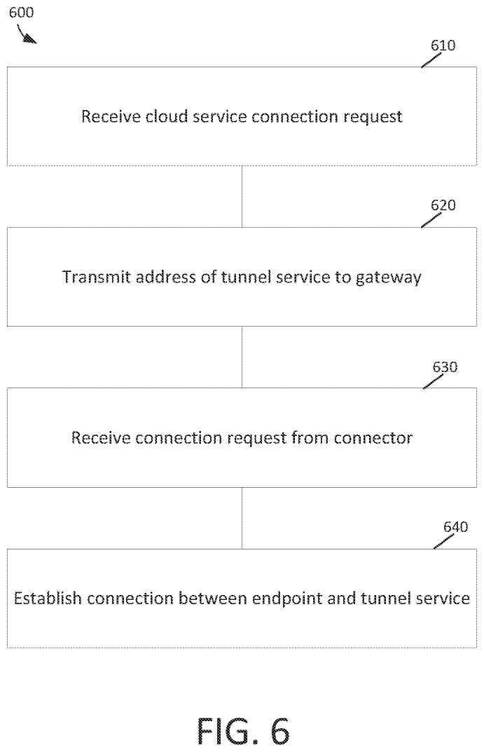

Referring now to FIG. 6, a diagram of a method 600 for establishing connectivity across networks is depicted. In brief summary, the method 600 includes operation 610, at which a cloud service connection request is received. At operation 620, an address of a tunnel service is provided to a gateway service. At operation 630, a connection request is received from a connector. A connection is established between the endpoint and the tunnel service at operation 640.

At operation 610, the tunnel service 330 receives a request from a cloud service 390 to establish a connection with an endpoint 370. For example, a user may attempt to access a cloud service 390 via a terminal 380. The user, the terminal 380, or the cloud service 390 may input an identifier including a credential which the cloud service 390 causes to be conveyed to the tunnel service 330. For example, the cloud service 390 may provide the access credentials to an addressable server 320 (e.g., an addressable authentication, authorization, and accounting (AAA) server through a shared memory space accessible to the cloud service 390). In some embodiments, the cloud service 390 and the addressable server 320 share one or more processors or memory spaces. The addressable server 320 (e.g., a server executing a service or micro service of an AAA function) may, responsive to the receipt of the credential, pass the identifier to a tunnel service 330. For example, the addressable server 320 may send the credential to the tunnel service 330 by a similar manner as the credential was provided to the addressable server 320, or the addressable server 320 may pass the message over a communications link (e.g., an Ethernet connection or a shared memory) which is monitored by the tunnel service 330 whereby the tunnel service 330 may intercept the message (e.g., may intercept all messages or a subset thereof).

At operation 620, the tunnel service 330 transmits an address associated with the tunnel service 330 to a gateway service 340. For example, the tunnel service 330 may recognize that a message is intended for delivery to an endpoint 370 a data center 350 associated with a connector 360 (e.g., based on an IP address, content, etc.). The gateway service 340 may include information relating to a plurality of resource locations including endpoints 370 of a data center 350 associated with the connector 360 (e.g., based on a connection with or a registration of the connector 360), to associate a message with a data center 350 or a connector 360. Responsive to that recognition or association, the tunnel service 330 may forward the message to the gateway service 340. The gateway service 340 may, responsive to the receipt of the message, forward the message to a connector 360 of the data center 350 which may, in turn, send an outbound connection request to one or more network nodes (e.g., over the internet or another network). For example, the connector 360 may send an outbound request to the tunnel service 330, which may include an FQDN to a desired node (e.g., the tunnel service 330). The connector may include or may interface with one or more firewalls 395. For example, a firewall 395 may block some or all inbound connections to the connector 360.

At operation 630, the tunnel service receives a connection request from the connector 360. For example, the connection request can include control signaling to instantiate a connection between the connector 360 (and a resource of an endpoint, such as an authorization which is responsive to the credentials supplied at operation 610). The tunnel service 330 may verify the connection based on one or more identifier associated with the connection request, which may be unique to a connection request, to a network node involved in the connection request, or otherwise indicate an authorization (e.g., an authorization token or shared key).

At operation 640, the tunnel service 330 establishes a connection between the endpoint 370 and the tunnel service 330. For example, the tunnel service 330 may establish connection information such as a port and IP, based on the previously established control signals to establish a connection whereby an endpoint of a data center 350 may, responsive to receipt of user credentials, authorize an access to one or more resources such as a cloud application, file, service, etc. For example, the endpoint 370 may provide an authorization token or authorization connection to validate a user access control, responsive to an inspection of the user credential indicating an authorization associated with the credentials.

If a user credential is not authorized to access a resource, an error message may be delivered to the user, or no communication may be delivered to the user (e.g., no outbound request may be sent by the connector 360). Indeed, various operations disclosed herein may require verification, validation, decryption, etc. Failures of various processes may result in error messages or a failure to perform some operations. For example, a security posture may indicate that upon a failure, no error message should be provided, or a failure may render a network node unable to provide an error message.

The disclosed operations are intended to be illustrative of a sequence of connection establishment operations. The depicted operations are not intended to be limiting. Indeed, many embodiments may omit, substitute, or append various operations as may be useful to provide acknowledgement, messaging, handshaking, and security, as may be useful for various embodiments. For example, the various disclosures provided herein may be incorporated between the various methods and systems disclosed. For example, the request may be received from a terminal, rather than a cloud service at operation 610.

### D. Example Embodiments

The following examples pertain to further example embodiments, from which permutations and configurations will be apparent.

Example 1 includes a method. The method includes receiving, by a tunnel service, a request from a cloud service to establish a connection with an endpoint. The method includes transmitting, by the tunnel service, an address of the tunnel service to a gateway service to cause the gateway service to forward the address to a connector of the data center. The method includes receiving, by the tunnel service, from the connector responsive to the connector receiving the address, a connection request for the connection. The method includes establishing, by the tunnel service, the connection between the endpoint and the tunnel service.

Example 2 includes the subject matter of Example 1, wherein receiving the request comprises intercepting, by the tunnel service, the request from the cloud service.

Example 3 includes the subject matter of any of Examples 1 and 2, further comprising configuring the tunnel service on at least one of a server hosting the cloud service or a cloud-service side device, wherein receiving the request is responsive to the tunnel service being configured.

Example 4 includes the subject matter of any of Examples 1 through 3, wherein the address is a fully-qualified domain name of the tunnel service.

Example 5 includes the subject matter of any of Examples 1 through 4, wherein the connection comprises an end-to-end tunnel between the endpoint and a server hosting the cloud service.

Example 6 includes the subject matter of any of Examples 1 through 5, further comprising transmitting, by the cloud service to the connector, an interne protocol (IP) address and port of the endpoint.

Example 7 includes the subject matter of any of Examples 1 through 6, wherein establishing the connection is responsive to the cloud service transmitting the IP address and port of the endpoint to the connector.

Example 8 includes the subject matter of any of Examples 1 through 7, wherein the connection request is an outbound connection request originating from the connector.

Example 9 includes the subject matter of any of Examples 1 through 8, further comprising determining, by the tunnel service, that the connection request received from the connector corresponds to the request to establish the connection received from the cloud service and wherein establishing the connection is responsive to the determination.

Example 10 includes the subject matter of any of Examples 1 through 9, wherein determining that the connection request corresponds to the request to establish the connection comprises receiving, by the tunnel service from the gateway service, a first identifier corresponding to the connection, and associating, by the tunnel service, the connection request received from the connector with the request to establish the connection based on the first identifier matching a second identifier included in the connection request.

Example 11 includes a system. The system includes a server hosting a cloud service, and a tunnel service deployed on at least one of the server or a cloud-service side device. The tunnel service is configured to receive a request from the cloud service to establish a connection with an endpoint. The tunnel service is configured to transmit an address of the tunnel service to a gateway service to cause the gateway service to forward the address to a connector of the data center. The tunnel service is configured to receive, from the connector responsive to the connector receiving the address, a connection request for the connection. The tunnel service is configured to establish the connection between the endpoint and the tunnel service.

Example 12 includes the subject matter of claim 11, wherein the tunnel service is configured to receive the request by intercepting the request from the cloud service.

Example 13 includes the subject matter of any of Examples 11 through 12, wherein the address is a fully-qualified domain name of the tunnel service.

Example 14 includes the subject matter of any of Examples 11 through 13, wherein the connection comprises an end-to-end tunnel between the endpoint and a server hosting the cloud service.

Example 15 includes the subject matter of any of Examples 11 through 14, wherein the cloud service is configured to transmit, to the connector, an internet protocol (IP) address and port of the endpoint.

Example 16 includes the subject matter of any of Examples 11 through 15, wherein establishing the connection is responsive to the cloud service transmitting the IP address and port of the endpoint to the connector.

Example 17 includes the subject matter of any of Examples 11 through 16, wherein the connection request is an outbound connection request originating from the connector.

Example 18 includes the subject matter of any of Examples 11 through 17, wherein the tunnel service is configured to determine that the connection request received from the connector corresponds to the request to establish the connection received from the cloud service, and wherein establishing the connection is responsive to the determination.

Example 19 includes the subject matter of any of Examples 11 through 18, wherein to determine that the connection request corresponds to the request to establish the connection, the tunnel service is configured to receive, from the gateway service, a first identifier corresponding to the connection, and associate the connection request received from the connector with the request to establish the connection based on the first identifier matching a second identifier included in the connection request.

Example 20 includes a non-transitory computer readable medium storing program instructions that, when executed by one or more processors, cause the one or more processors to receive a request from a cloud service to establish a connection with an endpoint. The computer-readable medium further stores instructions that cause the one or more processors to transmit an address of the tunnel service to a gateway service to cause the gateway service to forward the address to a connector of the data center. The computer-readable medium further stores instructions that cause the one or more processors to receive, from the connector responsive to the connector receiving the address, a connection request for the connection. The computer-readable medium further stores instructions that cause the one or more processors to establish the connection between the endpoint and the tunnel service.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer-readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer-readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method, comprising:
receiving, by a tunnel service, a request from a cloud service to establish a connection with an endpoint of a data center;
transmitting, by the tunnel service, an address of the tunnel service to a gateway service to cause the gateway service to forward the address to a connector of the data center;
receiving, by the tunnel service, from the connector responsive to the connector receiving the address from the gateway service, a connection request for the connection outbound from the connector; and
establishing, by the tunnel service, the connection between the endpoint and the tunnel service through the connector.

2. The method of claim 1, wherein receiving the request comprises intercepting, by the tunnel service, the request from the cloud service.

3. The method of claim 1, further comprising configuring the tunnel service on at least one of a server hosting the cloud service or a cloud-service side device, wherein receiving the request is responsive to the tunnel service being configured.

4. The method of claim 1, wherein the address is a fully-qualified domain name of the tunnel service.

5. The method of claim 1, wherein the connection comprises a tunnel between the endpoint and a server hosting the cloud service.

6. The method of claim 1, further comprising transmitting, by the cloud service to the connector, an internet protocol (IP) address and port of the endpoint.

7. The method of claim 6, wherein establishing the connection is responsive to the cloud service transmitting the IP address and port of the endpoint to the connector.

8. (canceled)

9. The method of claim 1, further comprising:
determining, by the tunnel service, that the connection request received from the connector corresponds to the request to establish the connection received from the cloud service,
wherein establishing the connection is responsive to the determination.

10. The method of claim 9, wherein determining that the connection request corresponds to the request to establish the connection comprises:
receiving, by the gateway service from the tunnel service, a first identifier corresponding to the connection; and
associating, by the tunnel service, the connection request received from the connector with the request to establish the connection based on the first identifier matching a second identifier included in the connection request.

11. A system comprising:
a server hosting a cloud service; and
a tunnel service deployed on at least one of the server or a cloud-service side device, the tunnel service configured to:
receive a request from the cloud service to establish a connection with an endpoint;
transmit an address of the tunnel service to a gateway service to cause the gateway service to forward the address to a connector of a data center;
receive, from the connector responsive to the connector receiving the address from the gateway service, a connection request for the connection outbound from the connector; and
establish the connection between the endpoint and the tunnel service through the connector.

12. The system of claim 11, wherein the tunnel service is configured to receive the request by intercepting the request from the cloud service.

13. The system of claim 11, wherein the address is a fully-qualified domain name of the tunnel service.

14. The system of claim 11, wherein the connection comprises a tunnel between the endpoint and the server hosting the cloud service.

15. The system of claim 11, wherein the cloud service is configured to transmit, to the connector, an internet protocol (IP) address and port of the endpoint.

16. The system of claim 15, wherein establishing the connection is responsive to the cloud service transmitting the IP address and port of the endpoint to the connector.

17. (canceled)

18. The system of claim 11, wherein the tunnel service is configured to:
determine that the connection request received from the connector corresponds to the request to establish the connection received from the cloud service,
wherein establishing the connection is responsive to the determination.

19. The system of claim 18, wherein to determine that the connection request corresponds to the request to establish the connection, the tunnel service is configured to:
provide, to the gateway service, a first identifier corresponding to an authorization to initiate the connection; and
associate the connection request received from the connector with the request to establish the connection based on the first identifier matching a second identifier included in the connection request.

20. A non-transitory computer readable medium storing instructions that, when executed by one or more processors, cause the one or more processors to:
receive a request from a cloud service to establish a connection with an endpoint;
transmit an address of a tunnel service to a gateway service to cause the gateway service to forward the address to a connector of a data center;
receive, from the connector responsive to the connector receiving the address from the gateway service, a connection request for the connection outbound from the connector; and
establish the connection between the endpoint and the tunnel service through the connector.
